(19) United States
(12) Patent Application Publication
(10) Pub. No.: US 2026/0100790 A1
(43) Pub. Date: Apr. 9, 2026

(54) DYNAMIC SOUNDING REFERENCE SIGNAL ANTENNA SWITCHING WITH TRANSMISSION CARRIER SWITCHING

(71) Applicant: QUALCOMM Incorporated, San Diego, CA (US)

(72) Inventors: Michael Paul CYRAN, Nuremberg (DE); Jae Ho RYU, San Diego, CA (US); Pranay Sudeep RUNGTA, New York, NY (US); Rahul SHARMA, San Diego, CA (US); Enoch Shiao-Kuang LU, San Diego, CA (US); Hari SANKAR, San Diego, CA (US); Yi HUANG, San Diego, CA (US)

(21) Appl. No.: 19/186,417

(22) Filed: Apr. 22, 2025

Related U.S. Application Data
(60) Provisional application No. 63/703,732, filed on Oct. 4, 2024.

(51) Int. Cl. H04L 5/00; H04B 7/08

(52) U.S. Cl. CPC H04L 5/0048; H04B 7/0802

(57) ABSTRACT

Various aspects of the present disclosure generally relate to wireless communication. In some aspects, a user equipment (UE) may receive an indication of a sounding reference signal (SRS) antenna switching (AS) configuration associated with a plurality of SRS AS types associated with different quantities of transmission chains.

The UE may select, from the plurality of SRS AS types, an SRS AS type for a first carrier based on a quantity of transmission chains available for the first carrier. The UE may transmit, in a transmission interval, one or more uplink signals on one or more of the first carrier or a second carrier according to the selected SRS AS type, wherein the one or more uplink signals include one or more of an SRS or an uplink communication. Numerous other aspects are described.

### CROSS-REFERENCE TO RELATED APPLICATION

This Patent Application claims priority to U.S. Provisional Ser. No. 63/703,732, filed on Oct. 4, 2024, entitled “DYNAMIC SOUNDING REFERENCE SIGNAL ANTENNA SWITCHING WITH TRANSMISSION CARRIER SWITCHING,” and assigned to the assignee hereof. The disclosure of the prior Application is considered part of and is incorporated by reference into this Patent Application.

### FIELD OF THE DISCLOSURE

Aspects of the present disclosure generally relate to wireless communication and specifically relate to techniques, apparatuses, and methods associated with dynamic sounding reference signal antenna switching with transmission carrier switching.

### BACKGROUND

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

### SUMMARY

Some aspects described herein relate to a user equipment (UE). The UE may include a processing system that includes one or more processors and one or more code storing memories coupled with the one or more processors. The processing system may be configured to receive an indication of a sounding reference signal (SRS) antenna switching (AS) configuration associated with a plurality of SRS AS types associated with different quantities of transmission (Tx) chains. The processing system may be configured to select, from the plurality of SRS AS types, an SRS AS type for a first carrier based on a quantity of Tx chains available for the first carrier. The processing system may be configured to transmit, in a Tx interval, one or more uplink signals on one or more of the first carrier or a second carrier according to the selected SRS AS type, wherein the one or more uplink signals include one or more of an SRS or an uplink communication.

Some aspects described herein relate to a network node. The network node may include a processing system that includes one or more processors and one or more code storing memories coupled with the one or more processors. The processing system may be configured to transmit an indication of an SRS AS configuration associated with a plurality of SRS AS types associated with different quantities of Tx chains. The processing system may be configured to receive one or more uplink signals on one or more of a first carrier or a second carrier, wherein the one or more uplink signals include one or more of an SRS or an uplink communication.

Some aspects described herein relate to a method of wireless communication performed by a UE. The method may include receiving an indication of an SRS AS configuration associated with a plurality of SRS AS types associated with different quantities of Tx chains. The method may include selecting, from the plurality of SRS AS types, an SRS AS type for a first carrier based on a quantity of Tx chains available for the first carrier. The method may include transmitting, in a Tx interval, one or more uplink signals on one or more of the first carrier or a second carrier according to the selected SRS AS type, wherein the one or more uplink signals include one or more of an SRS or an uplink communication.

Some aspects described herein relate to a method of wireless communication performed by a network node. The method may include transmitting an indication of an SRS AS configuration associated with a plurality of SRS AS types associated with different quantities of Tx chains. The method may include receiving one or more uplink signals on one or more of a first carrier or a second carrier, wherein the one or more uplink signals include one or more of an SRS or an uplink communication.

Some aspects described herein relate to a non-transitory computer-readable medium that stores a set of instructions for wireless communication by a UE. The set of instructions, when executed by one or more processors of the UE, may cause the UE to receive an indication of an SRS AS configuration associated with a plurality of SRS AS types associated with different quantities of Tx chains. The set of instructions, when executed by one or more processors of the UE, may cause the UE to select, from the plurality of SRS AS types, an SRS AS type for a first carrier based on a quantity of Tx chains available for the first carrier. The set of instructions, when executed by one or more processors of the UE, may cause the UE to transmit, in a Tx interval, one or more uplink signals on one or more of the first carrier or a second carrier according to the selected SRS AS type, wherein the one or more uplink signals include one or more of an SRS or an uplink communication.

Some aspects described herein relate to a non-transitory computer-readable medium that stores a set of instructions for wireless communication by a network node. The set of instructions, when executed by one or more processors of the network node, may cause the network node to transmit an indication of an SRS AS configuration associated with a plurality of SRS AS types associated with different quantities of Tx chains. The set of instructions, when executed by one or more processors of the network node, may cause the network node to receive one or more uplink signals on one or more of a first carrier or a second carrier, wherein the one or more uplink signals include one or more of an SRS or an uplink communication.

Some aspects described herein relate to an apparatus for wireless communication. The apparatus may include means for receiving an indication of an SRS AS configuration associated with a plurality of SRS AS types associated with different quantities of Tx chains. The apparatus may include means for selecting, from the plurality of SRS AS types, an SRS AS type for a first carrier based on a quantity of Tx chains available for the first carrier. The apparatus may include means for transmitting, in a Tx interval, one or more uplink signals on one or more of the first carrier or a second carrier according to the selected SRS AS type, wherein the one or more uplink signals include one or more of an SRS or an uplink communication.

Some aspects described herein relate to an apparatus for wireless communication. The apparatus may include means for transmitting an indication of an SRS AS configuration associated with a plurality of SRS AS types associated with different quantities of Tx chains. The apparatus may include means for receiving one or more uplink signals on one or more of a first carrier or a second carrier, wherein the one or more uplink signals include one or more of an SRS or an uplink communication.

Aspects of the present disclosure may generally be implemented by or as a method, apparatus, system, computer program product, non-transitory computer-readable medium, UE, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network.

FIG. 2 is a diagram illustrating an example disaggregated network node architecture.

FIG. 3 is a diagram illustrating an example of sounding reference signal (SRS) resource sets.

FIG. 4 is a diagram illustrating an example of bands and antenna switching.

FIG. 5 is a diagram illustrating an example of transmission switching for uplink.

FIG. 6 is a diagram illustrating an example associated with SRS antenna switching (AS) type switching.

FIGS. 7 and 8 are diagrams illustrating examples associated with SRS AS type switching with a time division duplex (TDD) carrier and a frequency division duplex carrier.

FIG. 9 is a diagram illustrating an example of a port mapping rule.

FIGS. 10 and 11 are diagrams illustrating examples associated with SRS AS type switching with two TDD carriers.

FIGS. 12 and 13 are diagrams illustrating example processes associated with dynamic SRS AS with transmission carrier switching.

FIGS. 14 and 15 are diagrams of example apparatuses for wireless communication.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

In a wireless network, uplink transmit (Tx) switching may enable multiple uplink chains to be shared among multiple carrier bands with a quantity of Tx chains.

For example, two uplink chains may be shared among up to four bands, with up to two transmissions in each uplink chain. Accordingly, a user equipment (UE) may switch one or both Tx chains across carrier bands.

However, when a Tx chain switches from one band to a different band, transmissions are not possible during a switching period (e.g., a period of time in which the Tx chain switches from one band to another). If an uplink communication is scheduled on a band during the switching period, the uplink communication is cancelled. The uplink communication may be retransmitted at a later time. As a result, latency is increased by switching across bands.

The wireless network may configure the UE to transmit a sounding reference signal (SRS) in order to enable the wireless network to estimate a downlink channel to the UE (e.g., by measuring the SRS and applying channel reciprocity). In order to estimate the downlink channel across multiple antennas of the UE, the wireless network may configure the UE to alternate SRS transmissions over different antennas.

Accordingly, SRS antenna switching (AS) may be enabled on one or more time division duplex (TDD) carrier bands in a Tx switching application. For example, different SRS types include one-transmit, four-receive (1T4R) (e.g., one transmission at a time alternating over four receive antennas), two-transmit, four-receive (2T4R) (e.g., two transmissions at a time alternating over four receive antennas), two-transmit, six-receive (2T6R) (e.g., two transmissions at a time alternating over six receive antennas), or four-transmit, eight-receive (4T8R) (e.g., four transmissions at a time alternating over eight receive antennas), among other examples.

However, where only a single SRS AS type is enabled on a wireless network, the UE may need to switch periodically to the TDD carrier band (e.g., from a frequency division duplex (FDD) carrier band) to send an SRS, resulting in switching periods during each Tx switch. These switching periods may cause periodic scheduling gaps, uplink cancellations, and downlink interruptions. For example, where a wireless network uses a 2T4R AS type, the UE may switch both Tx chains to the TDD carrier band in order to transmit SRS. As a result, latency is increased on the FDD carrier band. Additionally, the UE may skip SRS transmissions where Tx switching is not available (e.g., when the UE is transmitting uplink communications on an FDD carrier band). As a result, accuracy of downlink channel estimation at the wireless network is decreased, which may degrade quality and reliability of future communications.

Various aspects relate generally to selecting an SRS AS type (for a first carrier, such as a TDD carrier) based on a quantity of transmission chains that are available. Some aspects more specifically relate to a UE using one transmission chain based on only one transmission chain being available. Alternatively, some aspects more specifically relate to a UE using a plurality of transmission chains based on more than one transmission chain being available. In some aspects, a network (e.g., via a network node) may instruct the UE to use a particular SRS AS type. In some aspects, the UE may use different port mapping schedules associated with different SRS AS types.

Particular aspects of the subject matter described in this disclosure can be implemented to realize one or more of the following potential advantages. In some examples, the described techniques can be used to reduce latency associated with a second carrier (such as an FDD carrier) by reducing switching to the first carrier when Tx chains are in use on the second carrier. Additionally, the described techniques can be used to speed up SRS transmission by switching to the first carrier when Tx chains are unused on the second carrier. In some examples, the network may instruct the UE to use a particular SRS AS type in order to improve accuracy of downlink channel estimation. Similarly, the UE may use the port mapping schedules to increase diversity of SRS transmissions across antennas and thus improve accuracy of downlink channel estimation.

As described above, wireless communication systems may be deployed to provide various services, which may involve carrying or supporting voice, text, other messaging, video, data, and/or other traffic. Some wireless communication systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

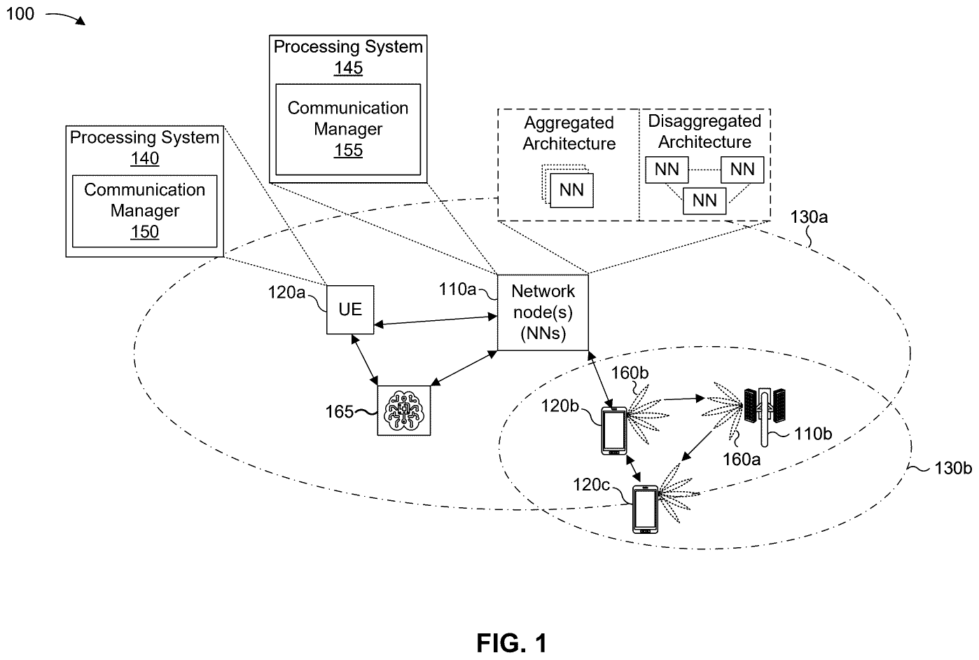

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a and a network node 110b. The network nodes 110 may support communications with multiple UEs 120. For example, in FIG. 1, the network nodes 110 support communication with a UE 120a, a UE 120b, and a UE 120c. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 110 and/or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 and/or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein.

Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for Tx or reception via an air interface) and a digital signal (such as for processing by the processing system 140 of the UE 120 or by the processing system 145 of the network node 110).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

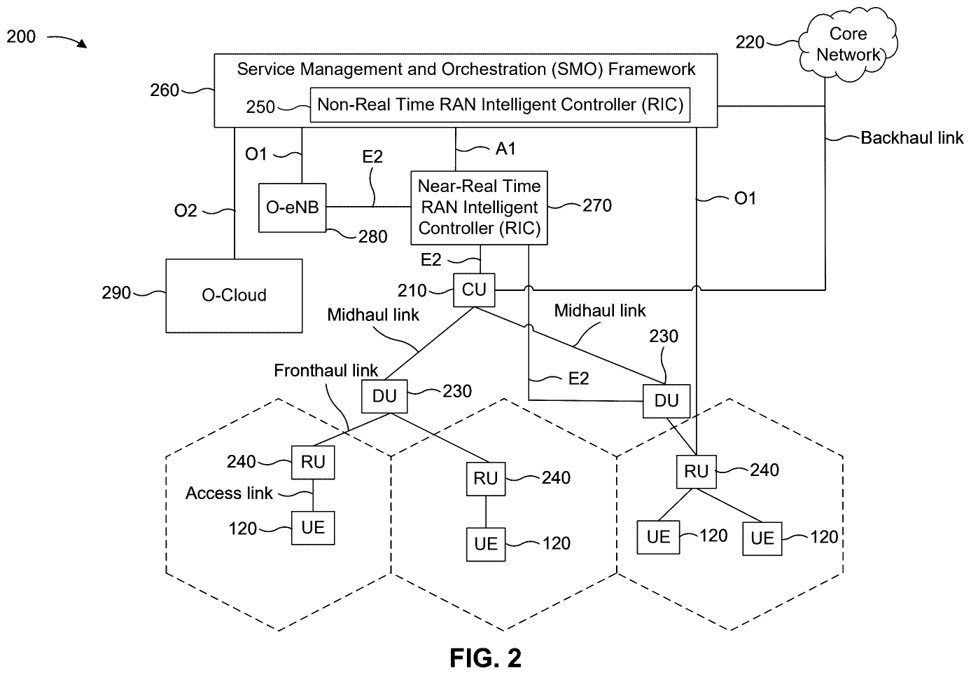

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a and a cell 130b), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, smart jewelry, a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) and/or reconfigured (for example, in real-time or near-real-time) according to changing network conditions in the wireless communication network 100 and/or specific requirements of one or more UEs 120. An active BWP defines the operating bandwidth of the UE 120 within the operating bandwidth of the serving cell.

The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot formal indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include an SRS, a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively.

For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), and/or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 145 or the processing system 140, respectively, and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a random access channel (RACH) operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state and/or a quasi co-location (QCL) parameter, among other examples. The network node 110 and the UE 120 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 165 (for example, a network node 110 and/or UEs 120). For example, the one or more devices 165 may include a UE 120 (for example, the processing system 140), a network node 110 (for example, the processing system 145), one or more servers, and/or one or more components of a cloud computing network, among other examples. In some examples, the AI/ML model (or an instance of the AI/ML model) may be deployed at multiple devices (for example, a first portion of the AI/ML model may be deployed at a UE 120 and a second portion of the AI/ML model may be deployed at a network node 110). In other examples, a first AI/ML model may be deployed at a UE 120 and a second AI/ML model may be deployed at a network node 110. The AI/ML model(s) may be configured to enhance various aspects of the wireless communication network 100. For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

In some aspects, the UE 120 may include a processing system 140, which includes a communication manager 150. As described in more detail elsewhere herein, the communication manager 150 may receive (e.g., from the network node 110) an indication of an SRS AS configuration associated with a plurality of SRS AS types associated with different quantities of transmission chains; may select, from the plurality of SRS AS types, an SRS AS type for a first carrier based on a quantity of transmission chains available for the first carrier; and may transmit (e.g., to the network node 110 in a transmission interval) one or more uplink signals on one or more of the first carrier or a second carrier according to the selected SRS AS type, where the one or more uplink signals include one or more of an SRS or an uplink communication.

Additionally, or alternatively, the communication manager 150 may perform one or more other operations described herein.

In some aspects, the network node 110 may include a processing system 145, which includes a communication manager 155. As described in more detail elsewhere herein, the communication manager 155 may transmit (e.g., to the UE 120) an indication of an SRS AS configuration associated with a plurality of SRS AS types associated with different quantities of transmission chains and may receive (e.g., from the UE 120) one or more uplink signals on one or more of a first carrier or a second carrier, where the one or more uplink signals include one or more of an SRS or an uplink communication. Additionally, or alternatively, the communication manager 155 may perform one or more other operations described herein.

FIG. 2 is a diagram illustrating an example disaggregated network node architecture 200, in accordance with the present disclosure. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 and/or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers.

Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, and/or policy-based guidance of applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

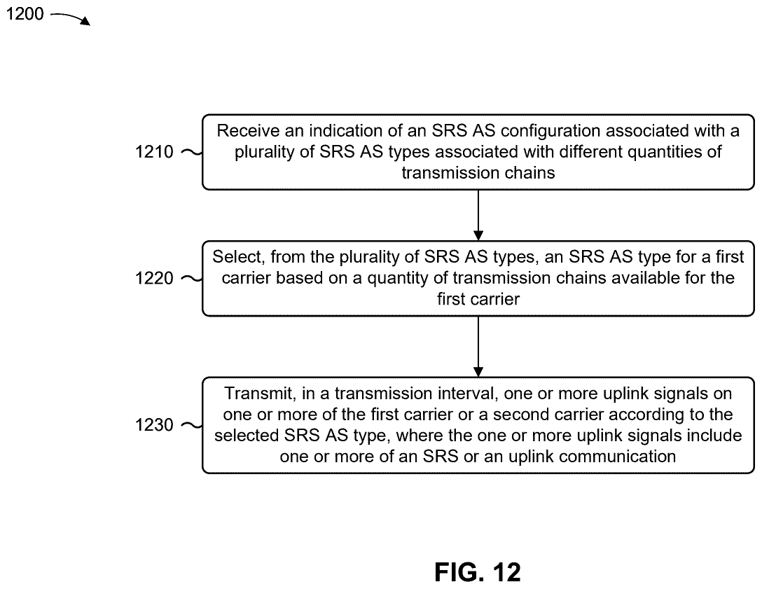

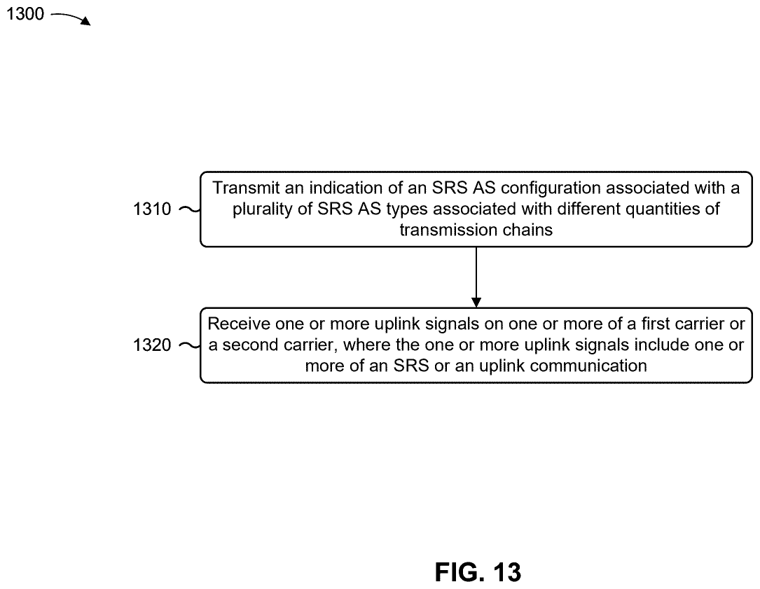

The network node 110, the processing system 145 of the network node 110, the UE 120, the processing system 140 of the UE 120, the CU 210, the DU 230, the RU 240, or any other component(s) of FIG. 1 and/or FIG. 2 may implement one or more techniques or perform one or more operations associated with dynamic SRS AS with Tx carrier switching, as described in more detail elsewhere herein. For example, the processing system 145 of the network node 110, the processing system 140 of the UE 120, the CU 210, the DU 230, or the RU 240 may perform or direct operations of, for example, process 1200 of FIG. 12, process 1300 of FIG. 13, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 1200 of FIG. 12, process 1300 of FIG. 13, or other processes as described herein. In some examples, executing instructions may include running the instructions, converting the instructions, compiling the instructions, and/or interpreting the instructions, among other examples.

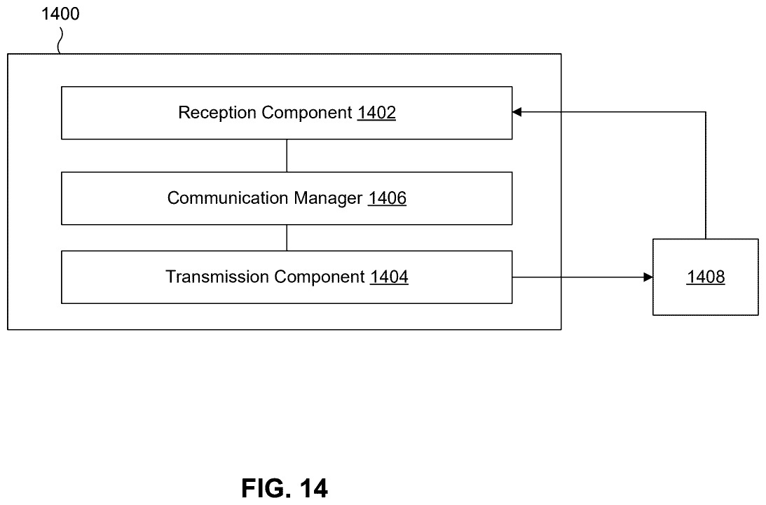

In some aspects, a UE (e.g., the UE 120 and/or apparatus 1400 of FIG. 14) may include means for receiving, from a network node, an indication of an SRS AS configuration associated with a plurality of SRS AS types associated with different quantities of Tx chains; means for selecting, from the plurality of SRS AS types, an SRS AS type for a first carrier based on a quantity of Tx chains available for the first carrier; and/or means for transmitting, to the network node in a Tx interval, one or more uplink signals on one or more of the first carrier or a second carrier according to the selected SRS AS type, wherein the one or more uplink signals include one or more of an SRS or an uplink communication. The means for the UE to perform operations described herein may include, for example, one or more of communication manager 150, processing system 140, a radio, one or more RF chains, one or more transceivers, one or more antennas, one or more modems, a reception component (for example, reception component 1402 depicted and described in connection with FIG. 14), and/or a transmission component (for example, transmission component 1404 depicted and described in connection with FIG. 14), among other examples.

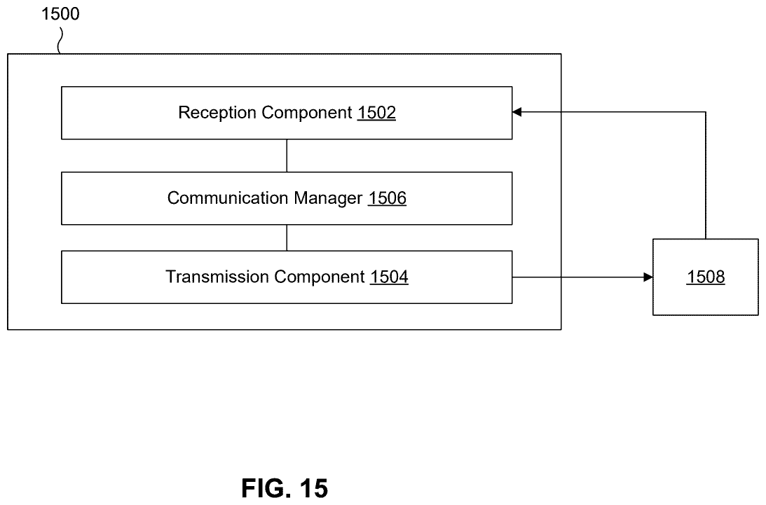

In some aspects, a network node (e.g., the network node 110, the CU 210, the DU 230, the RU 240, and/or apparatus 1500 of FIG. 15) may include means for transmitting, to a UE, an indication of an SRS AS configuration associated with a plurality of SRS AS types associated with different quantities of Tx chains; and/or means for receiving, from the UE, one or more uplink signals on one or more of a first carrier or a second carrier, wherein the one or more uplink signals include one or more of an SRS or an uplink communication. The means for the network node to perform operations described herein may include, for example, one or more of communication manager 155, processing system 145, a radio, one or more RF chains, one or more transceivers, one or more antennas, one or more modems, a reception component (for example, reception component 1502 depicted and described in connection with FIG. 15), and/or a transmission component (for example, transmission component 1504 depicted and described in connection with FIG. 15), among other examples.

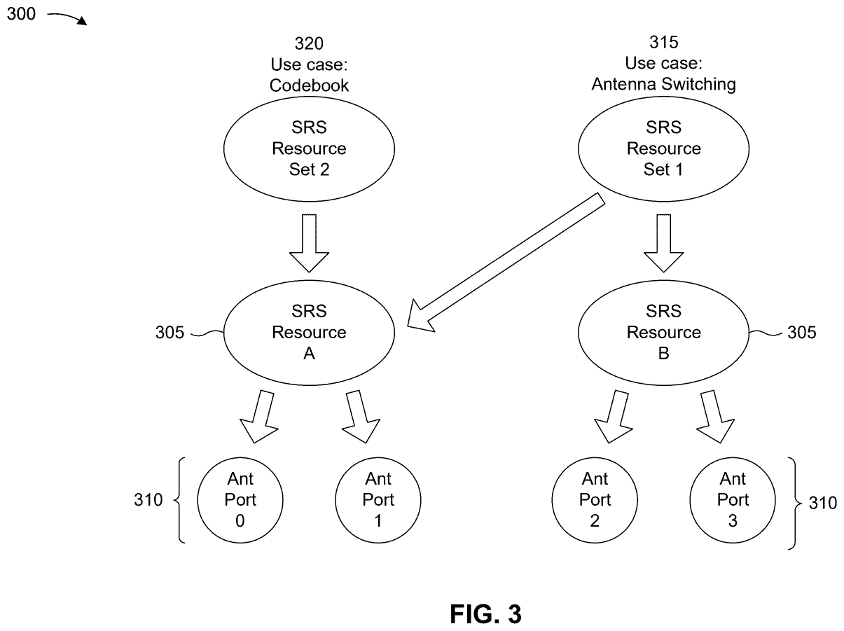

FIG. 3 is a diagram illustrating an example 300 of SRS resource sets, in accordance with the present disclosure. A UE 120 may be configured with one or more SRS resource sets to allocate resources for SRS transmissions by the UE 120. For example, a configuration for SRS resource sets may be indicated in an RRC message (e.g., an RRC configuration message or an RRC reconfiguration message). As shown by reference number 305, an SRS resource set may include one or more resources (e.g., shown as SRS resources), which may include time resources and/or frequency resources (e.g., a slot, a symbol, a resource block, and/or a periodicity for the time resources).

As shown by reference number 310, an SRS resource may include one or more antenna ports on which an SRS is to be transmitted (e.g., in a time-frequency resource). Thus, a configuration for an SRS resource set may indicate one or more time-frequency resources in which an SRS is to be transmitted and may indicate one or more antenna ports on which the SRS is to be transmitted in those time-frequency resources. In some aspects, the configuration for an SRS resource set may indicate a use case (e.g., in an SRS-SetUse information element) for the SRS resource set. For example, an SRS resource set may have a use case of antenna switching, codebook, non-codebook, or beam management.

An antenna switching SRS resource set may be used to indicate downlink CSI with reciprocity between an uplink channel and a downlink channel. For example, when there is reciprocity between an uplink channel and a downlink channel, a network node 110 may use an antenna switching SRS (e.g., an SRS transmitted using a resource of an antenna switching SRS resource set) to acquire downlink CSI (e.g., to determine a downlink precoder to be used to communicate with the UE 120).

A codebook SRS resource set may be used to indicate uplink CSI when a network node 110 indicates an uplink precoder to the UE 120. For example, when the network node 110 is configured to indicate an uplink precoder to the UE 120 (e.g., using a precoder codebook), the network node 110 may use a codebook SRS (e.g., an SRS transmitted using a resource of a codebook SRS resource set) to acquire uplink CSI (e.g., to determine an uplink precoder to be indicated to the UE 120 and used by the UE 120 to communicate with the network node 110). In some aspects, virtual ports (e.g., a combination of two or more antenna ports) with a maximum transmit power may be supported at least for a codebook SRS.

A non-codebook SRS resource set may be used to indicate uplink CSI when the UE 120 selects an uplink precoder (e.g., instead of the network node 110 indicating an uplink precoder to be used by the UE 120). For example, when the UE 120 is configured to select an uplink precoder, the network node 110 may use a non-codebook SRS (e.g., an SRS transmitted using a resource of a non-codebook SRS resource set) to acquire uplink CSI. In this case, the non-codebook SRS may be precoded using a precoder selected by the UE 120 (e.g., which may be indicated to the network node 110).

A beam management SRS resource set may be used for indicating CSI for millimeter wave communications.

An SRS resource can be configured as periodic, semi-persistent (sometimes referred to as semi-persistent scheduling (SPS)), or aperiodic. A periodic SRS resource may be configured via a configuration message that indicates a periodicity of the SRS resource (e.g., a slot-level periodicity, where the SRS resource occurs every Y slots) and a slot offset. In some cases, a periodic SRS resource may always be activated, and may not be dynamically activated or deactivated. A semi-persistent SRS resource may also be configured via a configuration message that indicates a periodicity and a slot offset for the semi-persistent SRS resource, and may be dynamically activated and deactivated (e.g., using DCI or a medium access control (MAC) control element (CE) (MAC-CE)). An aperiodic SRS resource may be triggered dynamically, such as via DCI (e.g., UE-specific DCI or group common DCI) or a MAC-CE.

In some aspects, the UE 120 may be configured with a mapping between SRS ports (e.g., antenna ports) and corresponding SRS resources. The UE 120 may transmit an SRS on a particular SRS resource using an SRS port indicated in the configuration. In some aspects, an SRS resource may span N adjacent symbols within a slot (e.g., where N equals 1, 2, or 4). The UE 120 may be configured with X SRS ports (e.g., where X≤4). In some aspects, each of the X SRS ports may mapped to a corresponding symbol of the SRS resource and used for transmission of an SRS in that symbol.

As shown in FIG. 3, in some aspects, different SRS resource sets indicated to the UE 120 (e.g., having different use cases) may overlap (e.g., in time and/or in frequency, such as in the same slot). For example, as shown by reference number 315, a first SRS resource set (e.g., shown as SRS Resource Set 1) is shown as having an antenna switching use case. As shown, this example antenna switching SRS resource set includes a first SRS resource (shown as SRS Resource A) and a second SRS resource (shown as SRS Resource B). Thus, antenna switching SRSs may be transmitted in SRS Resource A (e.g., a first time-frequency resource) using antenna port 0 and antenna port 1 and may be transmitted in SRS Resource B (e.g., a second time-frequency resource) using antenna port 2 and antenna port 3.

As shown by reference number 320, a second SRS resource set (e.g., shown as SRS Resource Set 2) may be a codebook use case. As shown, this example codebook SRS resource set includes only the first SRS resource (shown as SRS Resource A).

Thus, codebook SRSs may be transmitted in SRS Resource A (e.g., the first time-frequency resource) using antenna port 0 and antenna port 1. In this case, the UE 120 may not transmit codebook SRSs in SRS Resource B (e.g., the second time-frequency resource) using antenna port 2 and antenna port 3.

As indicated above, FIG. 3 is provided as an example. Other examples may differ from what is described with regard to FIG. 3.

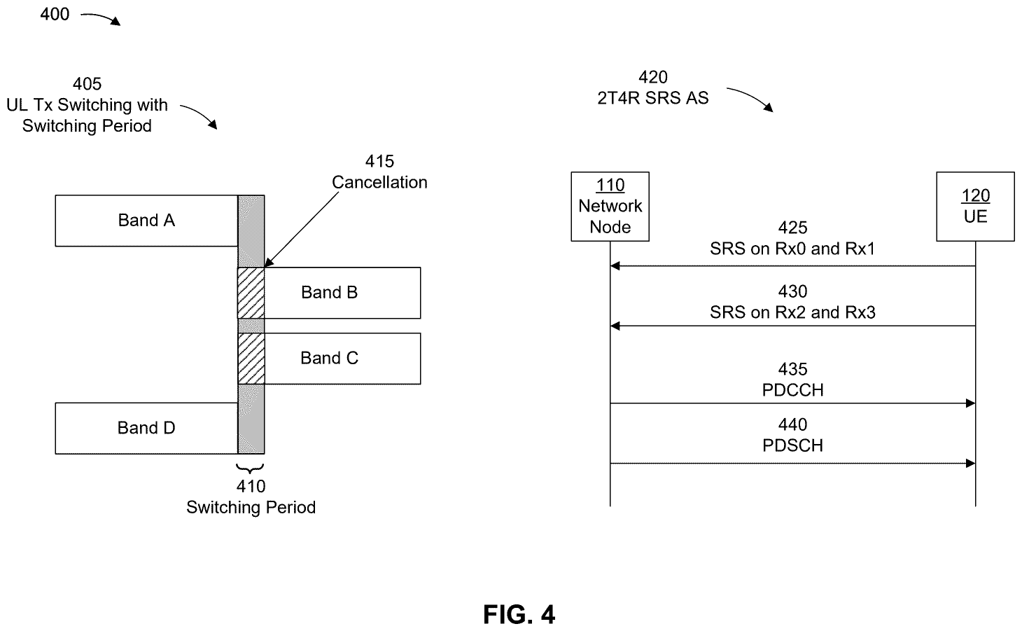

FIG. 4 is a diagram illustrating an example 400 of bands and antenna switching, in accordance with the present disclosure. FIG. 4 depicts an example 405 of uplink (UL) Tx switching with a switching period. In the example 405, a UE 120 may use four different frequency bands (shown as “Band A,” “Band B,” “Band C,” and “Band D”) for uplink. In order to switch bands (e.g., from Bands A and D to Bands B and C in the example 405), the UE 120 may use a switching period 410 to move Tx chains across bands (e.g., by using different antennas and/or recalibrating antennas accordingly). Therefore, any transmissions scheduled during the switching period 410 (regardless of band) are cancelled, as shown by reference number 415.

FIG. 4 further depicts an example 420 of an SRS AS type. The example 420 is of 2T4R. Accordingly, the example 420 uses two Tx chains across four antennas. In order to ensure that an SRS is transmitted across all four antennas, a network node 110 may configure the UE 120 to alternate the Tx chains across the antennas. Accordingly, as shown by reference number 425, the UE 120 may transmit, and the network node 110 may measure (e.g., directly or via an RU 240), an SRS transmitted using a first antenna (also referred to as “Rx0”) and a second antenna (also referred to as “Rx1”). The UE 120 may switch, according to 2T4R SRS AS, to a third antenna (also referred to as “Rx2”) and a fourth antenna (also referred to as “Rx3”) to transmit the SRS, as shown by reference number 430. The network node 110 may use measurements of the SRS to schedule downlink messages to the UE 120. Accordingly, as shown by reference number 435, the network node 110 may transmit (e.g., directly or via the RU 240), and the UE 120 may receive, a PDCCH message to schedule a downlink message.

Additionally, as shown by reference number 440, the network node 110 may transmit (e.g., directly or via the RU 240), and the UE 120 may receive, a PDSCH message that includes the downlink message.

As indicated above, FIG. 4 is provided as an example. Other examples may differ from what is described with regard to FIG. 4.

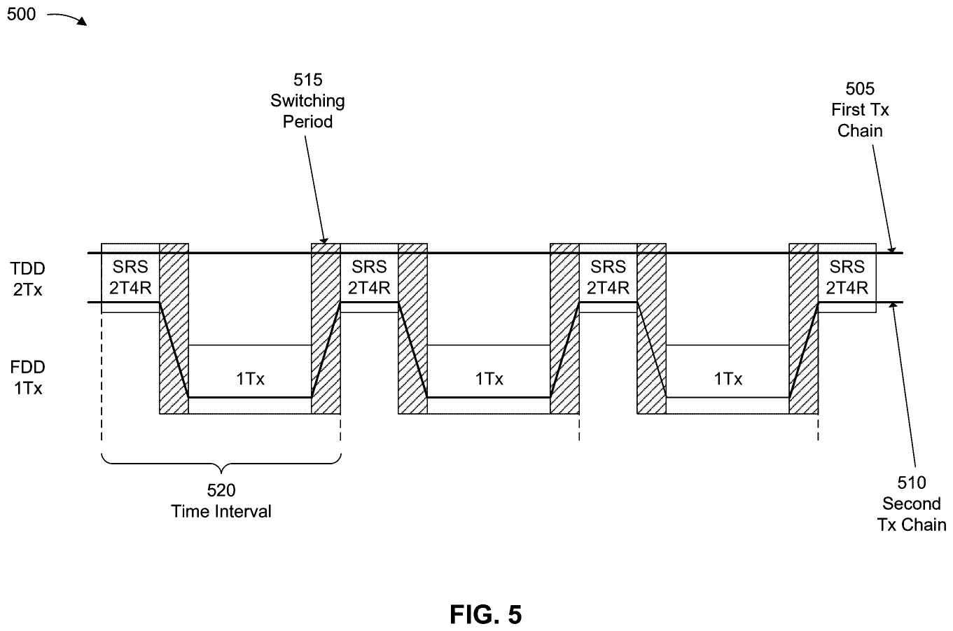

FIG. 5 is a diagram illustrating an example 500 of Tx switching for uplink, in accordance with the present disclosure. As shown in FIG. 5, a UE 120 may use two Tx chains on a TDD carrier (e.g., in a 2T4R SRS AS type) and a single Tx chain on an FDD carrier. Therefore, FIG. 5 indicates a first Tx chain 505 and a second Tx chain 510. In order to perform 2T4R SRS AS (e.g., as described in connection with FIG. 4), the UE 120 may switch the second Tx chain 510 from the FDD carrier to the TDD carrier (and optionally back to the FDD carrier) within a time interval 520, which incurs a switching period 515 each time the Tx chain 510 is shifted between carriers.

As indicated above, FIG. 5 is provided as an example. Other examples may differ from what is described with regard to FIG. 5.

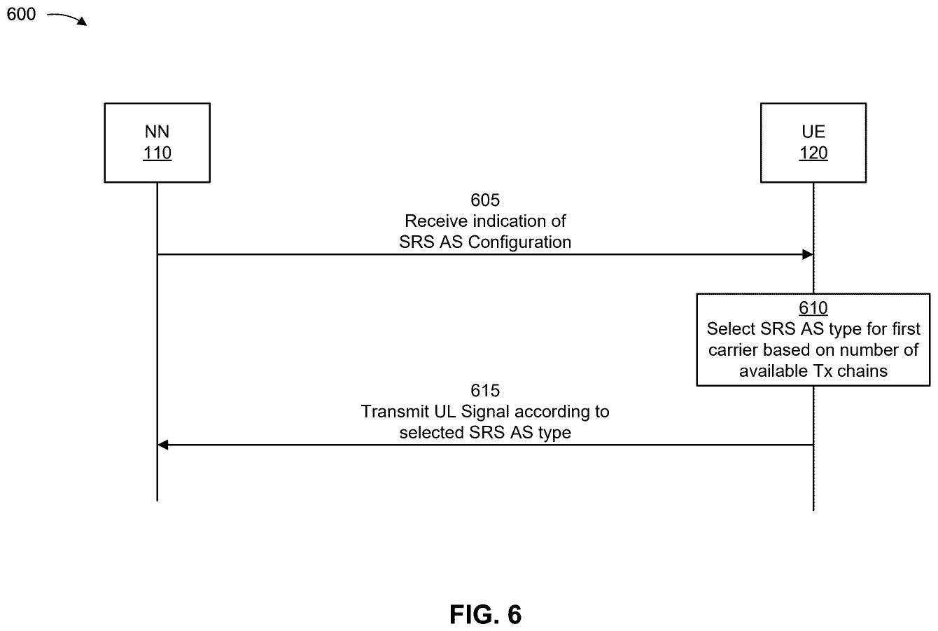

FIG. 6 is a diagram illustrating an example 600 associated with SRS AS type switching, in accordance with the present disclosure. As shown in FIG. 6, a network node 110 (e.g., an RU 240 and/or a device controlling the RU 240, such as a DU 230 and/or a CU 210) and a UE 120 may communicate with one another (e.g., OTA within a wireless network, such as the wireless communication network 100 of FIG. 1).

As shown by reference number 605, the network node 110 may transmit (e.g., directly or via the RU 240), and the UE 120 may receive, an indication of an SRS AS configuration. The SRS AS configuration may be associated with a plurality of SRS AS types associated with different quantities of transmission chains. The plurality of SRS AS types may include at least a first SRS AS type associated with a first quantity of transmission chains and a second SRS AS type associated with a second quantity of transmission chains. For example, the SRS AS types may include 1T4R, 2T4R, 2T6R, or 4T8R, among other examples. In some aspects, the SRS AS configuration may indicate the plurality of SRS AS types such that the UE 120 may switch between those SRS AS types (e.g., as described herein).

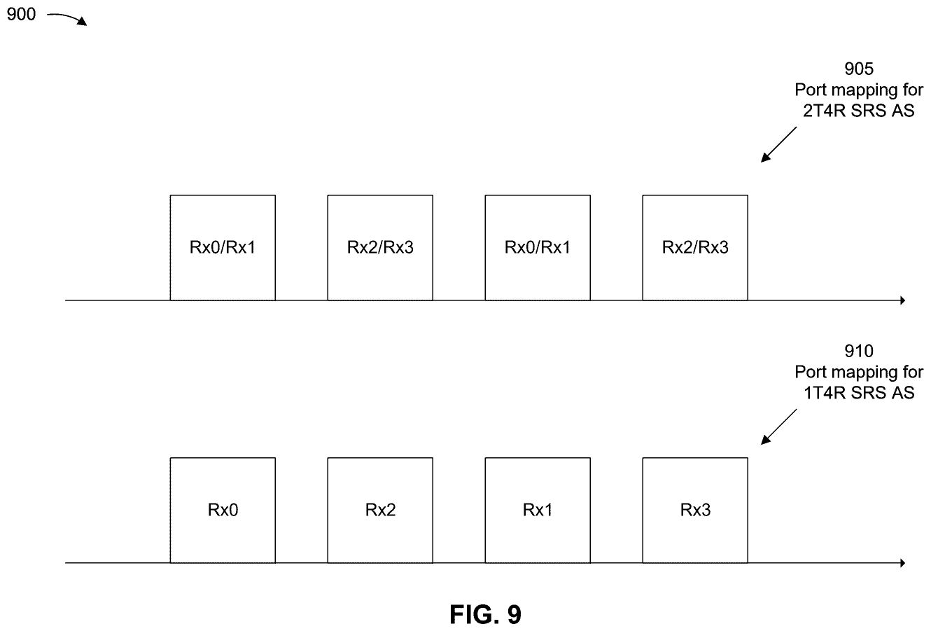

Additionally, the SRS AS configuration may indicate a plurality of SRS port mapping schedules that are each associated with a respective SRS AS type, of the plurality of SRS AS types. For example, the SRS port mapping schedules may be as described in connection with FIG. 9. In some aspects, the SRS port mapping schedules may be programmed into a memory of (or otherwise preconfigured for) the UE 120 (e.g., according to a standard, such as 3GPP specifications).

As shown by reference number 610, the UE 120 may select, from the plurality of SRS AS types, an SRS AS type for a first carrier based on a quantity of transmission chains available for the first carrier. For example, the UE 120 may select an SRS AS type with one Tx chain (e.g., 1T4R) in response to only one Tx chain being available in the first carrier (e.g., because other Tx chains are being used in the second carrier). In another example, the UE 120 may select an SRS AS type with a plurality of Tx chains (e.g., 2T4R or 2T6R, among other examples) in response to more than one Tx chain being available in the first carrier (e.g., because Tx chains are unused in the second carrier). In some aspects, the UE 120 may select the SRS AS type for the first carrier based on the quantity of transmission chains available for the first carrier at a time of a scheduled uplink transmission (e.g., an SRS or an uplink communication, such as a PUCCH indication or a PUSCH message). Accordingly, the UE 120 may dynamically perform selection of the SRS AS type according to scheduled uplink transmissions. For example, the UE 120 may select an SRS AS type for the first carrier with one Tx chain in a first transmission interval (e.g., because other Tx chains are scheduled in the second carrier) and select an SRS AS type for the first carrier with a plurality of Tx chains in a second transmission interval (e.g., because other Tx chains are unscheduled in the second carrier).

Although the example 600 is described in connection with dynamic selection of the SRS AS type by the UE 120, other examples may additionally or alternatively include the network node 110 selecting an SRS AS type for the UE 120 to use. For example, the network node 110 may transmit (e.g., directly or via the RU 240), and the UE 120 may receive, an indication to use the selected SRS AS type. The indication may include DCI or a MAC-CE, among other examples. Accordingly, the UE 120 may switch at least one transmission chain from a source carrier to a target carrier according to the indication. For example, the UE 120 may switch a Tx chain from the second carrier to the first carrier in order to select an SRS AS type with a plurality of Tx chains, consistent with the indication from the network node 110. As a result, the network node 110 may improve accuracy of downlink scheduling by increasing how many antennas are used for SRS (e.g., as described in connection with FIG. 4).

As shown by reference number 615, the UE 120 may transmit, and the network node 110 may receive (e.g., directly or via the RU 240), an uplink signal (e.g., one or more uplink signals) according to the selected SRS AS type. For example, the UE 120 may transmit the uplink signal on the first carrier and/or the second carrier according to the selected SRS AS type. In one example, the UE 120 may transmit SRSs on the first carrier with a plurality of Tx chains in a transmission interval (e.g., because 2T4R or another similar SRS AS type was selected based on other Tx chains being unscheduled in the second carrier during the transmission interval). In another example, the UE 120 may transmit an SRS on the first carrier with a single Tx chain in a transmission interval along with an uplink communication on the second carrier with another Tx chain in the transmission interval (e.g., because 1T4R or another similar SRS AS type was selected based on the other Tx chain being scheduled in the second carrier during the transmission interval). In another example, the UE 120 may refrain from transmitting an SRS on the first carrier (e.g., because all Tx chains were scheduled in the second carrier during the transmission interval).

By using techniques as described in connection with FIG. 6, the UE 120 may select the SRS AS type for the first carrier in order to avoid conflicts with the second carrier. As a result, latency is reduced for the second carrier because switching periods may be avoided.

As indicated above, FIG. 6 is provided as an example. Other examples may differ from what is described with respect to FIG. 6.

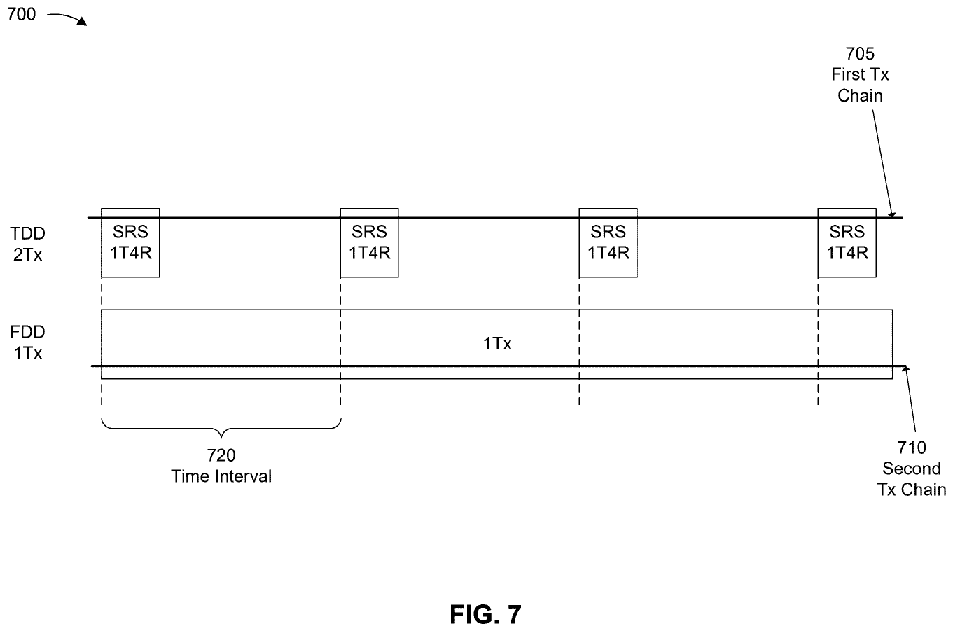

FIG. 7 is a diagram illustrating an example 700 of SRS AS type switching with a TDD carrier and an FDD carrier, in accordance with the present disclosure. As shown in FIG. 7, a UE 120 may use two Tx chains on the TDD carrier and a single Tx chain on the FDD carrier. Therefore, FIG. 7 indicates a first Tx chain 705 and a second Tx chain 710. Because the second Tx chain 710 is scheduled on the FDD carrier, the UE 120 may select 1T4R SRS AS (e.g., as described in connection with FIG. 6) in order to avoid switching the second Tx chain 710 from the FDD carrier to the TDD carrier (and back again), as described in connection with FIG. 5. Therefore, a switching period is absent from time interval 720, which reduces latency on the FDD carrier.

As indicated above, FIG. 7 is provided as an example. Other examples may differ from what is described with regard to FIG. 7.

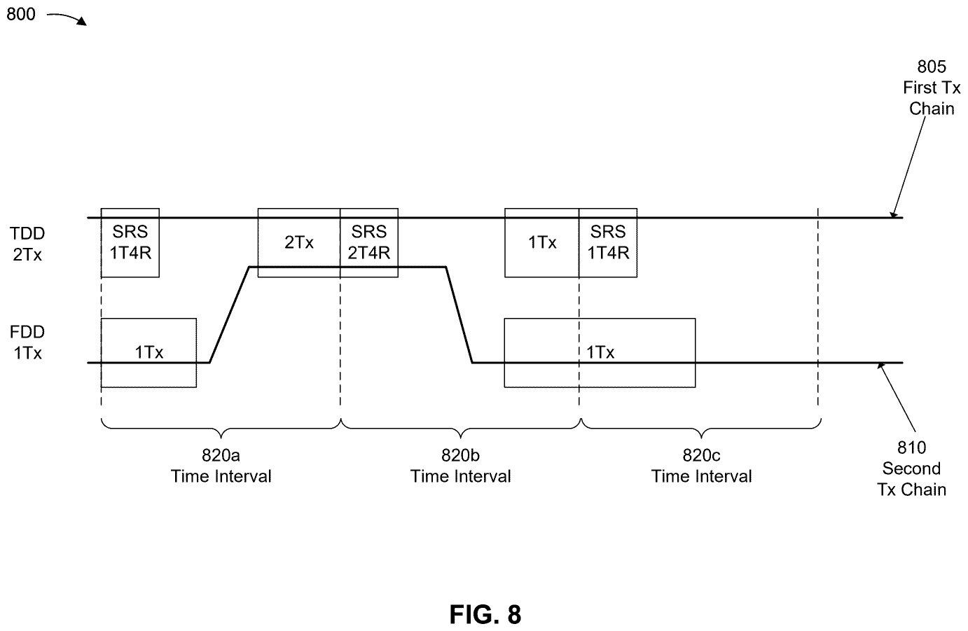

FIG. 8 is a diagram illustrating an example 800 of SRS AS type switching with a TDD carrier and an FDD carrier, in accordance with the present disclosure. As shown in FIG. 8, a UE 120 may use two Tx chains on the TDD carrier and a single Tx chain on the FDD carrier. Therefore, FIG. 8 indicates a first Tx chain 805 and a second Tx chain 810. In a beginning of a time interval 820a, the second Tx chain 810 is scheduled on the FDD carrier, so the UE 120 may select 1T4R SRS AS (e.g., as described in connection with FIG. 6) for the TDD carrier. Therefore, latency is reduced on the FDD carrier.

In a beginning of a time interval 820b, the second Tx chain 810 is unscheduled on the FDD carrier, so the UE 120 may select 2T4R SRS AS (e.g., as described in connection with FIG. 6) for the TDD carrier. Therefore, accuracy of measurements at a network is increased, and the network may improve quality and reliability of downlink messages on the TDD carrier by scheduling the downlink messages based on the measurements.

At a beginning of a time interval 820c, the second Tx chain 810 is again scheduled on the FDD carrier, so the UE 120 may select 1T4R SRS AS (e.g., as described in connection with FIG. 6) for the TDD carrier. Therefore, latency is again reduced on the FDD carrier.

As indicated above, FIG. 8 is provided as an example. Other examples may differ from what is described with regard to FIG. 8.

FIG. 9 is a diagram illustrating an example 900 of a port mapping rule, in accordance with the present disclosure. As shown in FIG. 9, the port mapping rule includes a port mapping schedule 905 associated with 2T4R SRS AS and a port mapping schedule 910 associated with 1T4R SRS AS. In the example 900, the port mapping schedule 905 clusters an Rx0 antenna with an Rx1 antenna and clusters an Rx2 antenna with an Rx3 antenna (e.g., as described in connection with FIG. 4). The port mapping schedule 910 includes the Rx0 and Rx1 antennas aligned with the Rx0/Rx1 cluster of the port mapping schedule 905. Additionally, the port mapping schedule 910 includes the Rx2 and Rx3 antennas aligned with the Rx2/Rx3 cluster of the port mapping schedule 905. As a result, the UE 120 alternates between antennas even when the UE 120 switches between 2T4R SRS AS and 1T4R SRS AS (e.g., as described in connection with FIG. 8), which increases accuracy of measurements at a network.

As indicated above, FIG. 9 is provided as an example. Other examples may differ from what is described with regard to FIG. 9.

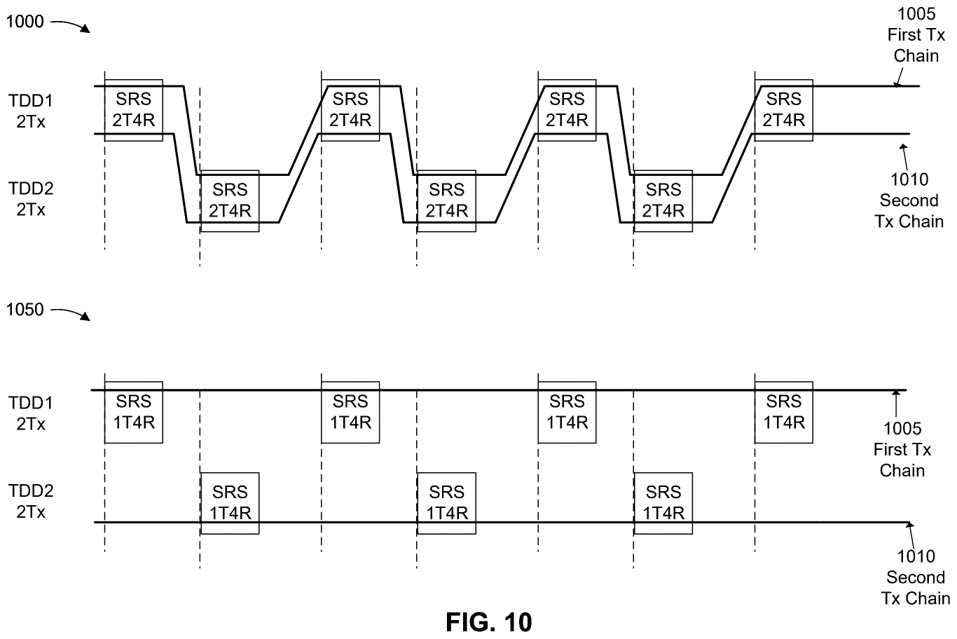

FIG. 10 is a diagram illustrating examples 1000 and 1050 of SRS AS type switching with two TDD carriers, in accordance with the present disclosure. As shown in FIG. 10, a UE 120 may use two Tx chains on a first TDD carrier (“TDD1”) and two Tx chains on a second TDD carrier (“TDD2”). Therefore, FIG. 10 indicates a first Tx chain 1005 and a second Tx chain 1010.

In the example 1000, a network may disallow the UE 120 from using 1T4R SRS AS. Accordingly, the UE 120 may fallback to switching the Tx chains 1005 and 1010 between TDD carriers.

In the example 1050, the network may allow the UE 120 to use 1T4R SRS AS. Accordingly, the UE 120 may avoid switching the Tx chains 1005 and 1010 between TDD carriers. As a result, latency is reduced overall for the UE 120 (on both TDD carriers).

As indicated above, FIG. 10 is provided as an example. Other examples may differ from what is described with regard to FIG. 10.

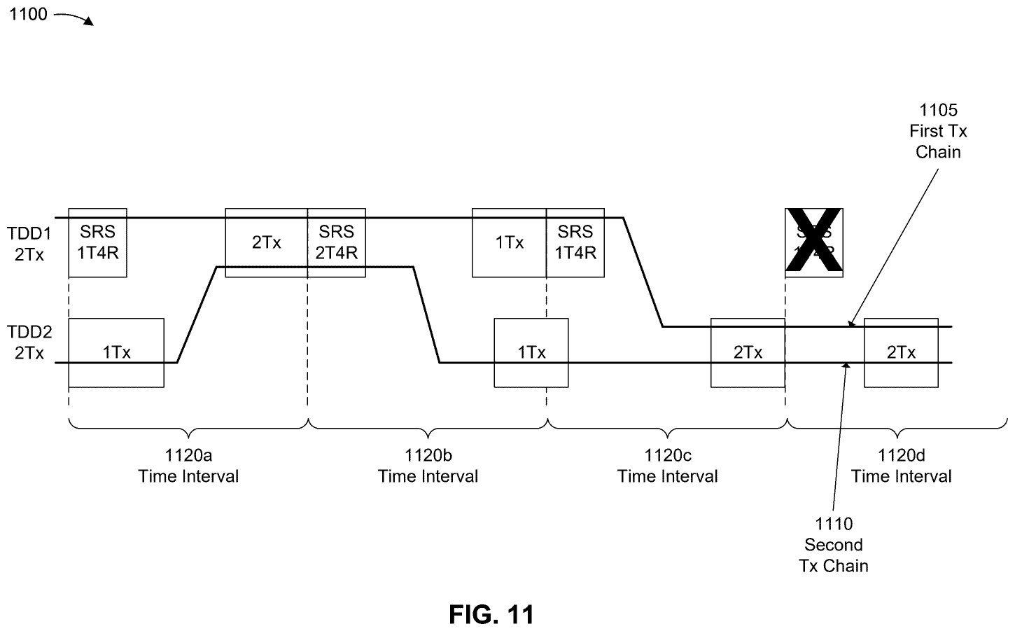

FIG. 11 is a diagram illustrating an example 1100 of SRS AS type switching with two TDD carriers, in accordance with the present disclosure. As shown in FIG. 11, a UE 120 may use two Tx chains on a first TDD carrier (“TDD1”) and two Tx chains on a second TDD carrier (“TDD2”). Therefore, FIG. 11 indicates a first Tx chain 1105 and a second Tx chain 1110. In a beginning of a time interval 1120a, the second Tx chain 1110 is scheduled on the second TDD carrier, so the UE 120 may select 1T4R SRS AS (e.g., as described in connection with FIG. 6) for the first TDD carrier. Therefore, latency is reduced on the second TDD carrier.

At an end of the time interval 1120a, both Tx chains 1105 and 1110 are transmitting on the first TDD carrier (and the second TDD carrier is unscheduled). As both chains are on TDD1 in a beginning of a time interval 1120b, the UE 120 may select 2T4R SRS AS (e.g., as described in connection with FIG. 6) for the first TDD carrier. Therefore, accuracy of measurements at a network is increased, and the network may improve quality and reliability of downlink messages on the first TDD carrier by scheduling the downlink messages based on the measurements.

At a beginning of a time interval 1120c, the second Tx chain 810 is again scheduled on the second TDD carrier, so the UE 120 may select 1T4R SRS AS (e.g., as described in connection with FIG. 6) for the first TDD carrier. Therefore, latency is again reduced on the second TDD carrier.

In a beginning of a time interval 1120d, both Tx chains 1105 and 1110 are scheduled on the second TDD carrier, so the UE 120 may refrain from transmitting an SRS on the first TDD carrier. Therefore, latency is again reduced on the second TDD carrier.

As indicated above, FIG. 11 is provided as an example. Other examples may differ from what is described with regard to FIG. 11.

FIG. 12 is a diagram illustrating an example process 1200 performed, for example, at a UE or an apparatus of a UE, in accordance with the present disclosure.

Example process 1200 is an example where the apparatus or the UE (e.g., UE 120) performs operations associated with dynamic SRS AS with Tx carrier switching.

As shown in FIG. 12, in some aspects, process 1200 may include receiving an indication of an SRS AS configuration associated with a plurality of SRS AS types associated with different quantities of transmission chains (block 1210). For example, the UE (e.g., using reception component 1402 and/or communication manager 1406, depicted in FIG. 14) may receive an indication of an SRS AS configuration associated with a plurality of SRS AS types associated with different quantities of transmission chains, as described herein.

As further shown in FIG. 12, in some aspects, process 1200 may include selecting, from the plurality of SRS AS types, an SRS AS type for a first carrier based on a quantity of transmission chains available for the first carrier (block 1220). For example, the UE (e.g., using communication manager 1406) may select, from the plurality of SRS AS types, an SRS AS type for a first carrier based on a quantity of transmission chains available for the first carrier, as described herein.

As further shown in FIG. 12, in some aspects, process 1200 may include transmitting, in a transmission interval, one or more uplink signals on one or more of the first carrier or a second carrier according to the selected SRS AS type, where the one or more uplink signals include one or more of an SRS or an uplink communication (block 1230). For example, the UE (e.g., using transmission component 1404 and/or communication manager 1406, depicted in FIG. 14) may transmit, in a transmission interval, one or more uplink signals on one or more of the first carrier or a second carrier according to the selected SRS AS type, where the one or more uplink signals include one or more of an SRS or an uplink communication, as described herein.

Process 1200 may include additional aspects, such as any single aspect or any combination of aspects described below and/or in connection with one or more other processes described elsewhere herein.

In a first aspect, the one or more uplink signals include the SRS based on at least one Tx chain being available in the first carrier.

In a second aspect, alone or in combination with the first aspect, the SRS is transmitted on the first carrier with a plurality of Tx chains based at least in part on more than one Tx chain being available in the first carrier.

In a third aspect, alone or in combination with one or more of the first and second aspects, the SRS is transmitted with one Tx chain based at least in part on only one Tx chain being available in the first carrier.

In a fourth aspect, alone or in combination with one or more of the first through third aspects, the SRS is not transmitted, based at least in part on no Tx chains being available in the first carrier.

In a fifth aspect, alone or in combination with one or more of the first through fourth aspects, the plurality of SRS AS types includes at least a first SRS AS type associated with a first quantity of Tx chains and a second SRS AS type associated with a second quantity of Tx chains.

In a sixth aspect, alone or in combination with one or more of the first through fifth aspects, process 1200 includes receiving (e.g., using reception component 1402 and/or communication manager 1406) an indication to use the selected SRS AS type, and switching (e.g., using transmission component 1404 and/or communication manager 1406) at least one Tx chain from a source carrier to a target carrier according to the indication.

In a seventh aspect, alone or in combination with one or more of the first through sixth aspects, the indication is received in a DCI message or a MAC CE.

In an eighth aspect, alone or in combination with one or more of the first through seventh aspects, the selection of the SRS AS type is further based on the quantity of transmission chains available for the first carrier at a time of a scheduled SRS transmission.

In a ninth aspect, alone or in combination with one or more of the first through eighth aspects, the SRS AS configuration includes a plurality of SRS port mapping schedules that are each associated with a respective SRS AS type, of the plurality of SRS AS types.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram illustrating an example process 1300 performed, for example, at a network node or an apparatus of a network node, in accordance with the present disclosure. Example process 1300 is an example where the apparatus or the network node (e.g., network node 110) performs operations associated with dynamic SRS AS with Tx carrier switching.

As shown in FIG. 13, in some aspects, process 1300 may include transmitting an indication of an SRS AS configuration associated with a plurality of SRS AS types associated with different quantities of transmission chains (block 1310). For example, the network node (e.g., using transmission component 1504 and/or communication manager 1506, depicted in FIG. 15) may transmit an indication of an SRS AS configuration associated with a plurality of SRS AS types associated with different quantities of transmission chains, as described herein.

As further shown in FIG. 13, in some aspects, process 1300 may include receiving one or more uplink signals on one or more of a first carrier or a second carrier, where the one or more uplink signals include one or more of an SRS or an uplink communication (block 1320). For example, the network node (e.g., using reception component 1502 and/or communication manager 1506, depicted in FIG. 15) may receive one or more uplink signals on one or more of a first carrier or a second carrier, where the one or more uplink signals include one or more of an SRS or an uplink communication, as described herein.

Process 1300 may include additional aspects, such as any single aspect or any combination of aspects described below and/or in connection with one or more other processes described elsewhere herein.

In a first aspect, the plurality of SRS AS types include at least a first SRS AS type associated with a first quantity of Tx chains and a second SRS AS type associated with a second quantity of Tx chains.

In a second aspect, alone or in combination with the first aspect, process 1300 includes receiving (e.g., using reception component 1502 and/or communication manager 1506) an indication of an antenna state associated with a quantity of Tx chains available and a selected SRS AS type, and transmitting (e.g., using transmission component 1504 and/or communication manager 1506) an indication to use the selected SRS AS type, where the indication is based on a difference between the antenna state associated with the quantity of Tx chains available and the selected SRS AS type.

In a third aspect, alone or in combination with one or more of the first and second aspects, the indication to use the selected SRS AS type is transmitted in a DCI message or a MAC CE.

In a fourth aspect, alone or in combination with one or more of the first through third aspects, the SRS AS configuration includes a plurality of SRS port mapping schedules that are each associated with a respective SRS AS type, of the plurality of SRS AS types.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

FIG. 14 is a diagram of an example apparatus 1400 for wireless communication, in accordance with the present disclosure. The apparatus 1400 may be a UE, or a UE may include the apparatus 1400. In some aspects, the apparatus 1400 includes a reception component 1402, a transmission component 1404, and/or a communication manager 1406, which may be in communication with one another (for example, via one or more buses and/or one or more other components). In some aspects, the communication manager 1406 is the communication manager 150 described in connection with FIG. 1. As shown, the apparatus 1400 may communicate with another apparatus 1408, such as a UE or a network node (such as a CU, a DU, an RU, or a base station), using the reception component 1402 and the transmission component 1404. The communication manager 1406 may be included in, or implemented via, a processing system (for example, the processing system 140 described in connection with FIG. 1) of the UE.

In some aspects, the apparatus 1400 may be configured to perform one or more operations described herein in connection with FIGS. 6-11. Additionally, or alternatively, the apparatus 1400 may be configured to perform one or more processes described herein, such as process 1200 of FIG. 12. In some aspects, the apparatus 1400 and/or one or more components shown in FIG. 14 may include one or more components of the UE described in connection with FIG. 1. Additionally, or alternatively, one or more components shown in FIG. 14 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1402 may receive communications, such as reference signals, control information, data communications, or a combination thereof, from the apparatus 1408. The reception component 1402 may provide received communications to one or more other components of the apparatus 1400. In some aspects, the reception component 1402 may perform signal processing on the received communications, and may provide the processed signals to the one or more other components of the apparatus 1400. In some aspects, the reception component 1402 may include one or more components of the UE described above in connection with FIG. 1, such as a radio, one or more RF chains, one or more transceivers, or one or more modems, each of which may in turn be coupled with one or more antennas of the UE.

The transmission component 1404 may transmit communications, such as reference signals, control information, data communications, or a combination thereof, to the apparatus 1408. In some aspects, one or more other components of the apparatus 1400 may generate communications and may provide the generated communications to the transmission component 1404 for transmission to the apparatus 1408. In some aspects, the transmission component 1404 may perform signal processing on the generated communications, and may transmit the processed signals to the apparatus 1408. In some aspects, the transmission component 1404 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 1404 may be co-located with the reception component 1402.

The communication manager 1406 may support operations of the reception component 1402 and/or the transmission component 1404. For example, the communication manager 1406 may receive information associated with configuring reception of communications by the reception component 1402 and/or transmission of communications by the transmission component 1404. Additionally, or alternatively, the communication manager 1406 may generate and/or provide control information to the reception component 1402 and/or the transmission component 1404 to control reception and/or transmission of communications.

The reception component 1402 may receive (e.g., from the apparatus 1408, such as a network node) an indication of an SRS AS configuration associated with a plurality of SRS AS types associated with different quantities of Tx chains. The communication manager 1406 may select, from the plurality of SRS AS types, an SRS AS type for a first carrier based on a quantity of Tx chains available for the first carrier. The transmission component 1404 may transmit (e.g., to the apparatus 1408 in a Tx interval) one or more uplink signals on one or more of the first carrier or a second carrier according to the selected SRS AS type. The one or more uplink signals may include one or more of an SRS or an uplink communication.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally, or alternatively, a set of (one or more) components shown in FIG. 14 may perform one or more functions described as being performed by another set of components shown in FIG. 14.

FIG. 15 is a diagram of an example apparatus 1500 for wireless communication, in accordance with the present disclosure. The apparatus 1500 may be a network node, or a network node may include the apparatus 1500. In some aspects, the apparatus 1500 includes a reception component 1502, a transmission component 1504, and/or a communication manager 1506, which may be in communication with one another (for example, via one or more buses and/or one or more other components). In some aspects, the communication manager 1506 is the communication manager 155 described in connection with FIG. 1. As shown, the apparatus 1500 may communicate with another apparatus 1508, such as a UE or a network node (such as a CU, a DU, an RU, or a base station), using the reception component 1502 and the transmission component 1504. The communication manager 1506 may be included in, or implemented via, a processing system (for example, the processing system 145 described in connection with FIG. 1) of the network node.

In some aspects, the apparatus 1500 may be configured to perform one or more operations described herein in connection with FIGS. 6-11. Additionally, or alternatively, the apparatus 1500 may be configured to perform one or more processes described herein, such as process 1300 of FIG. 13. In some aspects, the apparatus 1500 and/or one or more components shown in FIG. 15 may include one or more components of the network node described in connection with FIG. 1. Additionally, or alternatively, one or more components shown in FIG. 15 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1502 may receive communications, such as reference signals, control information, data communications, or a combination thereof, from the apparatus 1508. The reception component 1502 may provide received communications to one or more other components of the apparatus 1500. In some aspects, the reception component 1502 may perform signal processing on the received communications, and may provide the processed signals to the one or more other components of the apparatus 1500. In some aspects, the reception component 1502 may include one or more components of the network node described above in connection with FIG. 1, such as a radio, one or more RF chains, one or more transceivers, or one or more modems, each of which may in turn be coupled with one or more antennas of the network node. In some aspects, the reception component 1502 and/or the transmission component 1504 may include or may be included in a network interface. The network interface may be configured to obtain and/or output signals for the apparatus 1500 via one or more communications links, such as a backhaul link, a midhaul link, and/or a fronthaul link.

The transmission component 1504 may transmit communications, such as reference signals, control information, data communications, or a combination thereof, to the apparatus 1508. In some aspects, one or more other components of the apparatus 1500 may generate communications and may provide the generated communications to the transmission component 1504 for transmission to the apparatus 1508. In some aspects, the transmission component 1504 may perform signal processing on the generated communications, and may transmit the processed signals to the apparatus 1508. In some aspects, the transmission component 1504 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 1504 may be co-located with the reception component 1502.

The communication manager 1506 may support operations of the reception component 1502 and/or the transmission component 1504. For example, the communication manager 1506 may receive information associated with configuring reception of communications by the reception component 1502 and/or transmission of communications by the transmission component 1504. Additionally, or alternatively, the communication manager 1506 may generate and/or provide control information to the reception component 1502 and/or the transmission component 1504 to control reception and/or transmission of communications.

The transmission component 1504 may transmit (e.g., to the apparatus 1508, such as a UE) an indication of an SRS AS configuration associated with a plurality of SRS AS types associated with different quantities of Tx chains. The reception component 1502 may receive (e.g., from the apparatus 1508) one or more uplink signals on one or more of a first carrier or a second carrier. The one or more uplink signals may include one or more of an SRS or an uplink communication.

The number and arrangement of components shown in FIG. 15 are provided as an example. In practice, there may be additional components, fewer components, different components, or differently arranged components than those shown in FIG. 15. Furthermore, two or more components shown in FIG. 15 may be implemented within a single component, or a single component shown in FIG. 15 may be implemented as multiple, distributed components. Additionally, or alternatively, a set of (one or more) components shown in FIG. 15 may perform one or more functions described as being performed by another set of components shown in FIG. 15.

The following provides an overview of some Aspects of the present disclosure:

Aspect 1: A method of wireless communication performed by a user equipment (UE), comprising: receiving an indication of a sounding reference signal (SRS) antenna switching (AS) configuration associated with a plurality of SRS AS types associated with different quantities of transmission chains; selecting, from the plurality of SRS AS types, an SRS AS type for a first carrier based on a quantity of transmission chains available for the first carrier; and transmitting, in a transmission interval, one or more uplink signals on one or more of the first carrier or a second carrier according to the selected SRS AS type, wherein the one or more uplink signals include one or more of an SRS or an uplink communication.

Aspect 2: The method of Aspect 1, wherein the one or more uplink signals include the SRS based on at least one transmission chain being available in the first carrier.

Aspect 3: The method of Aspect 2, wherein the SRS is transmitted on the first carrier with a plurality of transmission chains based at least in part on more than one transmission chain being available in the first carrier.

Aspect 4: The method of Aspect 2, wherein the SRS is transmitted with one transmission chain based at least in part on only one transmission chain being available in the first carrier.

Aspect 5: The method of Aspect 2, wherein the SRS is not transmitted based at least in part on no transmission chains being available in the first carrier.

Aspect 6: The method of any of Aspects 1-5, wherein the plurality of SRS AS types includes at least a first SRS AS type associated with a first quantity of transmission chains and a second SRS AS type associated with a second quantity of transmission chains.

Aspect 7: The method of any of Aspects 1-6, further comprising: receiving an indication to use the selected SRS AS type; and switching at least one transmission chain from a source carrier to a target carrier according to the indication.

Aspect 8: The method of Aspect 7, wherein the indication is received in a downlink control information (DCI) message or a medium access control (MAC) control element (MAC CE).

Aspect 9: The method of any of Aspects 1-8, wherein the selection of the SRS AS type is further based on the quantity of transmission chains available for the first carrier at a time of a scheduled SRS transmission.

Aspect 10: The method of any of Aspects 1-9, wherein the SRS AS configuration includes a plurality of SRS port mapping schedules that are each associated with a respective SRS AS type, of the plurality of SRS AS types.

Aspect 11: A method of wireless communication performed by a network node, comprising: transmitting an indication of a sounding reference signal (SRS) antenna switching (AS) configuration associated with a plurality of SRS AS types associated with different quantities of transmission chains; and receiving one or more uplink signals on one or more of a first carrier or a second carrier, wherein the one or more uplink signals include one or more of an SRS or an uplink communication.

Aspect 12: The method of Aspect 11, wherein the plurality of SRS AS types include at least a first SRS AS type associated with a first quantity of transmission chains and a second SRS AS type associated with a second quantity of transmission chains.

Aspect 13: The method of any of Aspects 11-12, further comprising: receiving an indication of an antenna state associated with a quantity of transmission chains available and a selected SRS AS type; and transmitting an indication to use the selected SRS AS type, wherein the indication is based on a difference between the antenna state associated with the quantity of transmission chains available and the selected SRS AS type.

Aspect 14: The method of Aspect 13, wherein the indication to use the selected SRS AS type is transmitted in a downlink control information (DCI) message or a medium access control (MAC) control element (MAC CE).

Aspect 15: The method of any of Aspects 11-14, wherein the SRS AS configuration includes a plurality of SRS port mapping schedules that are each associated with a respective SRS AS type, of the plurality of SRS AS types.

Aspect 16: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-15.

Aspect 17: An apparatus for wireless communication at a device, the apparatus comprising one or more memories and one or more processors coupled to the one or more memories, the one or more processors configured to cause the device to perform the method of one or more of Aspects 1-15.

Aspect 18: An apparatus for wireless communication, the apparatus comprising at least one means for performing the method of one or more of Aspects 1-15.

Aspect 19: A non-transitory computer-readable medium storing code for wireless communication, the code comprising instructions executable by one or more processors to perform the method of one or more of Aspects 1-15.

Aspect 20: A non-transitory computer-readable medium storing a set of instructions for wireless communication, the set of instructions comprising one or more instructions that, when executed by one or more processors of a device, cause the device to perform the method of one or more of Aspects 1-15.

Aspect 21: A device for wireless communication, the device comprising a processing system that includes one or more processors and one or more memories coupled with the one or more processors, the processing system configured to cause the device to perform the method of one or more of Aspects 1-15.

Aspect 22: An apparatus for wireless communication at a device, the apparatus comprising one or more memories and one or more processors coupled to the one or more memories, the one or more processors individually or collectively configured to cause the device to perform the method of one or more of Aspects 1-15.

The foregoing disclosure provides illustration and description but is not intended to be exhaustive or to limit the aspects to the precise forms disclosed.

Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one. ” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE), comprising:
a processing system that includes one or more processors and one or more code storing memories coupled with the one or more processors, the processing system configured to cause the UE to:
receive an indication of a sounding reference signal (SRS) antenna switching (AS) configuration associated with a plurality of SRS AS types associated with different quantities of transmission chains;
select, from the plurality of SRS AS types, an SRS AS type for a first carrier based on a quantity of transmission chains available for the first carrier; and
transmit, in a transmission interval, one or more uplink signals on one or more of the first carrier or a second carrier according to the selected SRS AS type, wherein the one or more uplink signals include one or more of an SRS or an uplink communication.

2. The UE of claim 1, wherein the one or more uplink signals include the SRS based on at least one transmission chain being available in the first carrier.

3. The UE of claim 2, wherein the SRS is transmitted on the first carrier with a plurality of transmission chains based at least in part on more than one transmission chain being available in the first carrier.

4. The UE of claim 2, wherein the SRS is transmitted with one transmission chain based at least in part on only one transmission chain being available in the first carrier.

5. The UE of claim 2, wherein the SRS is not transmitted based at least in part on no transmission chains being available in the first carrier.

6. The UE of claim 1, wherein the plurality of SRS AS types includes at least a first SRS AS type associated with a first quantity of transmission chains and a second SRS AS type associated with a second quantity of transmission chains.

7. The UE of claim 1, wherein the processing system is configured to cause the UE to:
receive an indication to use the selected SRS AS type; and
switch at least one transmission chain from a source carrier to a target carrier according to the indication.

8. The UE of claim 1, wherein the SRS AS configuration includes a plurality of SRS port mapping schedules that are each associated with a respective SRS AS type, of the plurality of SRS AS types.

9. A method of wireless communication performed by a user equipment (UE), comprising:
receiving an indication of a sounding reference signal (SRS) antenna switching (AS) configuration associated with a plurality of SRS AS types associated with different quantities of transmission chains;
selecting, from the plurality of SRS AS types, an SRS AS type for a first carrier based on a quantity of transmission chains available for the first carrier; and
transmitting, in a transmission interval, one or more uplink signals on one or more of the first carrier or a second carrier according to the selected SRS AS type, wherein the one or more uplink signals include one or more of an SRS or an uplink communication.

10. The method of claim 9, wherein the one or more uplink signals include the SRS based on at least one transmission chain being available in the first carrier.

11. The method of claim 9, wherein the plurality of SRS AS types includes at least a first SRS AS type associated with a first quantity of transmission chains and a second SRS AS type associated with a second quantity of transmission chains.

12. The method of claim 9, further comprising:
receiving an indication to use the selected SRS AS type; and
switching at least one transmission chain from a source carrier to a target carrier according to the indication.

13. The method of claim 12, wherein the indication is received in a downlink control information (DCI) message or a medium access control (MAC) control element (MAC CE).

14. The method of claim 9, wherein the selection of the SRS AS type is further based on the quantity of transmission chains available for the first carrier at a time of a scheduled SRS transmission.

15. The method of claim 9, wherein the SRS AS configuration includes a plurality of SRS port mapping schedules that are each associated with a respective SRS AS type, of the plurality of SRS AS types.

16. A non-transitory computer-readable medium storing a set of instructions for wireless communication, the set of instructions comprising:
one or more instructions that, when executed by one or more processors of a user equipment (UE), cause the UE to:
receive an indication of a sounding reference signal (SRS) antenna switching (AS) configuration associated with a plurality of SRS AS types associated with different quantities of transmission chains;
select, from the plurality of SRS AS types, an SRS AS type for a first carrier based on a quantity of transmission chains available for the first carrier; and
transmit, in a transmission interval, one or more uplink signals on one or more of the first carrier or a second carrier according to the selected SRS AS type, wherein the one or more uplink signals include one or more of an SRS or an uplink communication.

17. The non-transitory computer-readable medium of claim 16, wherein the one or more uplink signals include the SRS based on at least one transmission chain being available in the first carrier.

18. The non-transitory computer-readable medium of claim 17, wherein the SRS is transmitted on the first carrier with a plurality of transmission chains based at least in part on more than one transmission chain being available in the first carrier.

19. The non-transitory computer-readable medium of claim 17, wherein the SRS is transmitted with one transmission chain based at least in part on only one transmission chain being available in the first carrier.

20. The non-transitory computer-readable medium of claim 16, wherein the plurality of SRS AS types includes at least a first SRS AS type associated with a first quantity of transmission chains and a second SRS AS type associated with a second quantity of transmission chains.
